(19) United States
(12) Patent Application Publication
(10) Pub. No.: US 2007/0003365 A1
(43) Pub. Date: Jan. 4, 2007

(54) Guard for protecting a pinch point

(75) Inventors: Michael A. Walt II, Chicago, IL (US); Samuel A. Walt, Dekalb, IL (US); James Collin, Dekalb, IL (US)

Correspondence Address: REINHART BOERNER VAN DEUREN P.C., 2215 PERRYGREEN WAY, ROCKFORD, IL, 61107, US

(73) Assignee: LMS-Walt Inc., Dekalb, IL (US)

(21) Appl. No.: 11/172,535

(22) Filed: Jun. 30, 2005

(51) Int. Cl. F16D 1/08

(52) U.S. Cl. 403/362

(57) ABSTRACT

A retractable plunger apparatus is provided. The plunger apparatus comprises a bushing, a plunger, a resilient member, and a guard. The bushing has an abutment while the plunger includes a handle, a counter abutment, and a locking element. The plunger is slideable relative to the bushing and moveable between a stopped position, where the counter abutment is engaged with the abutment, and a disengaged position displaced from the stopped position, where a gap is formed between the counter abutment and the abutment. The resilient member is supported by the bushing and urges the plunger and the bushing toward the stopped position. The guard protectively covers the gap as the plunger transitions between the stopped position and the disengaged position.

### FIELD OF THE INVENTION

This invention generally relates to a safety device and, more particularly, to a safety device for a spring plunger.

### BACKGROUND OF THE INVENTION

Hand-retractable spring plungers are often employed in industry for quick-connect and disconnect applications and to quickly and conveniently fasten, position, and latch adjacent pieces of material, equipment, and/or objects relative to one another.

The typical spring plunger apparatus is comprised of bushing, a resilient member, and a spring plunger that includes a pin and a handle. The bushing houses the resilient member which, in some cases, is spring that encircles the pin when the pin is inserted into the bushing. The spring is typically connected to both the bushing and the pin and, since the spring is in a somewhat of a compressed state, biases the handle of the plunger and the bushing toward each other. Often the pin is inserted into the bushing until a distal end portion of the pin, known as a locking element or nose, protrudes from an end of the bushing farthest away from the handle. When the spring plunger, and specifically the bushing, is mounted to or in a first piece of material, the locking element is permitted to extend into a socket or other detent formed in a second piece of material adjacent to the first piece of material. As such, the first and second pieces of material are secured together and unmoveable relative to each other.

If movement of the first piece of material relative to the second is desired, the spring plunger is transitioned from a stopped position, where the locking element protrudes into the socket in the second piece of material, to a disengaged position, where the locking element is extracted from the socket. To make this transition, the handle of the spring plunger is gripped by one or more fingers and/or a thumb and drawn away from the bushing. By exerting such a force on the handle, the resilient member is compressed and the locking element is retracted from within the socket in the second piece of material. With the locking element extricated from the socket, the first piece of material, which is still securing the spring plunger, is able to move relative to the second piece of material. In this state, the first piece of material can be repositioned and/or adjusted to a new or desired position. Once in the new position, which typically finds the locking element aligned with an additional socket in the second piece of material, the handle is released. The released handle permits the spring to expand and the locking element to be thrust into the additional socket. With the locking element disposed in the additional socket, the first and second pieces of material are once again secured, albeit releasably, to each other.

Unfortunately, during a transition by the spring plunger between the stopped position and the disengaged position, a gap or pinch point is formed between the handle and the bushing. More specifically, the gap is formed between an abutment on the bushing and a mating counter abutment on the handle. Since this gap is often very near the handle of the spring plunger, a user's fingers are exposed to the open gap and are sometimes undesirably and painfully pinched between the abutment and the counter abutment.

### BRIEF SUMMARY OF THE INVENTION

In one aspect, the invention provides a retractable plunger apparatus. The retractable plunger apparatus comprises a bushing, a plunger, a resilient member, and a guard. The bushing has an abutment and the plunger has a handle, a counter abutment, and a locking element. The plunger is slideable relative to the bushing and moveable between a stopped position wherein the counter abutment is engaged with the abutment and a disengaged position displaced from the stopped position wherein a gap is formed between the counter abutment and the abutment. The resilient member is supported by the bushing and urges the plunger and the bushing toward the stopped position. The guard protectively covers the gap as the plunger transitions between the stopped position and the disengaged position.

In another aspect, the invention provides a hand-retractable spring plunger. The hand retractable spring plunger apparatus comprises a plunger, a bushing, a spring, and a guard. The plunger has a handle, a pin, and a counter abutment. The bushing has an axial bore and an abutment. The pin is slideably received in the axial bore and protrudes from the bushing to form a locking element. The spring is housed in the bushing. The spring is operatively connected to the plunger and the bushing to urge the abutment and the counter abutment toward each other. The guard is securable to the bushing and covers a gap formed between the abutment and the counter abutment when the locking element is retracted into the bushing.

In yet another aspect, the invention provides a hand-retractable spring plunger system. The hand-retractable spring plunger system comprises a hand-retractable spring plunger, a first body, and a second body. The hand-retractable spring plunger apparatus includes a plunger, a bushing, a spring, and a guard. The plunger has a handle, a pin, and a counter abutment. The bushing has an axial bore and an abutment. The pin is slideably received in the axial bore and protrudes from the bushing to form a locking element. The spring is housed in the bushing. The spring is operatively connected to the plunger and the bushing to bias the abutment and the counter abutment toward each other. The guard is telescopically received over the bushing and covers a gap formed between the abutment and the counter abutment when the locking element is retracted into the bushing. The first body has an aperture. The bushing of the plunger apparatus is mounted within the aperture. The first body is locked relative to the second body via the locking element when the locking element is projecting from the bushing. The first body is moveable relative to the second body when the locking element is retracted against the bias of the spring.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded perspective view of an exemplary embodiment of a retractable plunger apparatus constructed in accordance with the teachings of the present invention;

FIG. 2 is a perspective view of the retractable plunger of FIG. 1 when assembled;

FIG. 3 is a cross-section view of the retractable plunger of FIG. 1 in a stopped position with the locking element projecting into a first socket;

FIG. 4 is a cross-section view of the retractable plunger of FIG. 1 in a disengaged position with the locking element retracted into the bushing and against the bias of the spring; and

FIG. 5 is a cross-section view of the retractable plunger of FIG. 1 in the stopped position with the locking element projected into a second socket spaced apart from the first socket.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

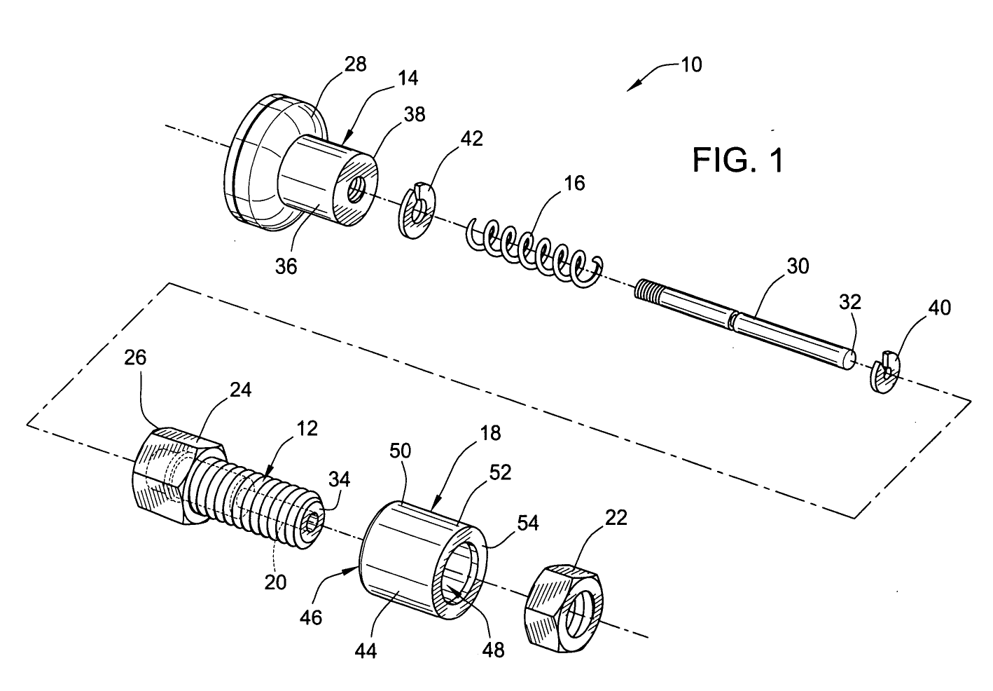

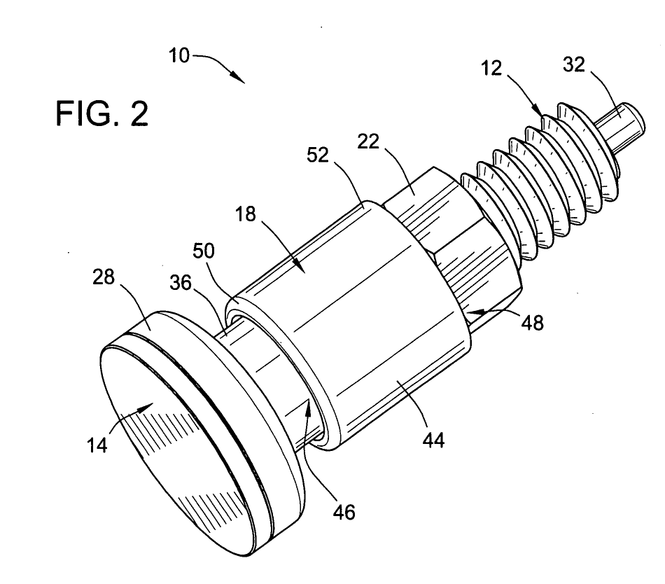

Referring to FIGS. 1 and 2, a retractable plunger apparatus 10 is illustrated. The retractable plunger apparatus 10 is used for fastening, locking, latching, and quick-connect and quick disconnect applications while advantageously keeping fingers and/or a thumb free from injury as will be explained more fully below. As shown in FIG. 1, the retractable plunger apparatus 10 generally comprises a bushing 12, a plunger 14, a resilient member 16, and a guard 18.

The bushing 12 is preferably cylindrical in shape and includes an axial bore 20 that progresses entirely through the bushing. Moreover, a portion of the bushing 12, as shown in FIG. 1, is threaded. In a preferred embodiment, a threaded nut 22 (i.e., a locking nut or locknut) is threadably mated with the threaded bushing 12 to secure the guard 18 to the bushing. The bushing 12 is available with both English and metric (SI) thread sizes such as, for example, #10-32, ¼″-20, 5/16″-18, ⅜″-16, ⅜″-24, ½″-13, ⅝″-11, ¾″-10, 1″-8, M5, M6, M10, and M12. Also, the metric thread pitch of the bushing 12 can be, for example, 0.8 mm, 1 mm, 1.5 mm, and 1.75 mm. The bushing 12 further includes and defines an abutment 24 that often possesses a very defined, and sometimes even sharp, edge 26.

The plunger 14 includes a handle 28 and a pin 30. The handle 28 and the pin 30 are secured together by one of several methods known in the art such as, for example, mating threads, epoxy, welding, and the like. The handle 28 is dimensioned and/or sized to comfortably accommodate one or more fingers and/or a thumb such that the handle can be gripped. In that regard, the handle 28 can be fashioned as a knob, a pull knob, a contoured delrin knob, an L-handle, a pull-ring, a T-handle, and the like, as well known by those skilled in the art. The pin 30, which is preferably cylindrical, is dimensioned to be slideably received within the axial bore 20 of the bushing 12 until a portion of the pin, known as a locking element 32 or nose, protrudes from an end 34 of the bushing furthest away from the handle 28. The plunger 14, and in particular the handle 28, further includes and defines a counter abutment 36 that often includes a very defined, and sometimes even sharp, edge 38.

The resilient member 16 is operatively connected to the plunger 14 and the bushing 12 such that the abutment 24 and the counter abutment 36 are biased and urged toward each other. In a preferred embodiment, the resilient member 16 is secured to and/or supported by the bushing 12. In the embodiment shown in FIG. 1, the resilient member 16 is illustrated as a spring that is slightly compressed yet resiliently expandable. Despite being illustrated as a spring, the resilient member 16 can be other resilient and/or compressible components or materials known to those skilled in the art such as, for example, a portion of rubber, a compressible gas, and the like.

In one embodiment, as illustrated in FIGS. 1 and 2, the resilient member 16 encircles the pin 30 and is operatively connected to the bushing 12 and the plunger 14 by a pair of snap rings 40, 42. The first snap ring 40 is connected to the pin 14 while the second snap ring 42 is connected to the bushing 12. The resilient member 16 is interposed between these snap rings 40, 42 such that the snap rings act as a boundary for the resilient member and compress, to varying degrees at different times, the resilient member. When compressed, the resilient member 16 biases or urges the plunger 14 and bushing 12, and more particularly the abutment 24 and the counter abutment 36, together and/or toward each other.

The guard 18 preferably includes a cylindrical body 44 and first and second circular openings 46, 48 at opposite ends 50, 52 of the body. The openings 46, 48 permit the guard 18 to be slid onto and pass over at least a portion, such as the threaded portion, of the bushing 12. In one embodiment, the guard 18 is telescopically received and slideable over the bushing 12 until the opening 48 catches upon the larger abutment 24. In a preferred embodiment, the guard 18 has an inward radial flange or lip 54 proximate the end 52. The lip 54 reduces the size of the second opening 48 (compared to the first opening 46) and is employable to engage the guard 18 with the bushing 12 and, in particular, the abutment 24.

In another preferred embodiment, one or both of the ends 50, 52 of the guard 18 are smoothed and/or radiused to remove the sharp edges or corners from the guard. Such softened portions, especially at end 50 most proximate the handle 28, inhibit and/or prevent injury to a finger, thumb, and even portions of a hand.

Although not shown, in one embodiment the locking nut 22 and the guard 18 can be combined into a single, integrally formed guard. In other words, the guard 18 can be fitted with threads to mate with the bushing 12 in embodiments where the bushing includes corresponding threads. When the retractable plunger apparatus 10 is assembled, as shown in FIG. 2, the guard 18 can be resting upon, proximate to, and/or secured to the abutment 24 of the bushing 12. Such engagements or associations of the guard 18 with the abutment 24 can be accomplished, in preferred embodiments, using the locking nut 22.

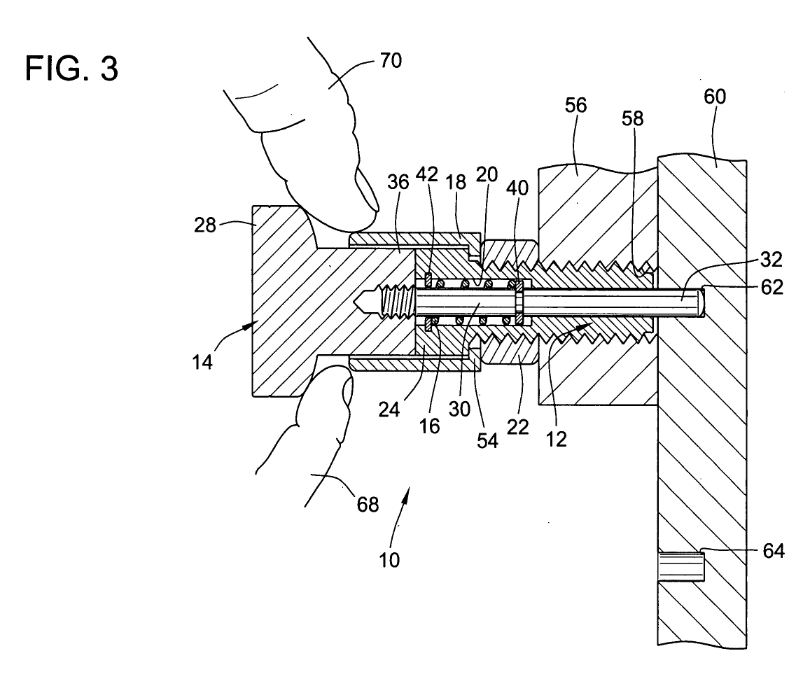

In operation, as shown in FIG. 3, the retractable plunger apparatus 10 is disposed within and/or secured to a first body 56. In a preferred embodiment, as FIG. 3 illustrates, the first body 56 includes a threaded bore 58 that threadably receives and secures the bushing 12, which also includes corresponding and mating threads. The second body 60 includes first and second sockets 62, 64 and is adjacent to the first body 56. Although sockets 62, 64 are depicted, those skilled in the art will recognize that apertures, grooves, an abraded surface, and the like can be used in place of the sockets.

Since the locking element 32 is projected into the first socket 62 on the second body 60 and the abutment 24 and counter abutment 36 are biased together, the retractable plunger apparatus 10 is said to be in a “stopped” position. In the stopped position, the first and second bodies 56, 60 are secured together such that relative movement between the two bodies is prevented or, at the least, inhibited. In other words, the first and second bodies 56, 60 are “locked” together. Notably, in the stopped position the resilient member 16 is preferably at least slightly compressed, and wanting to expand, to ensure that the abutment 24 and the counter abutment 36 are forcibly biased together.

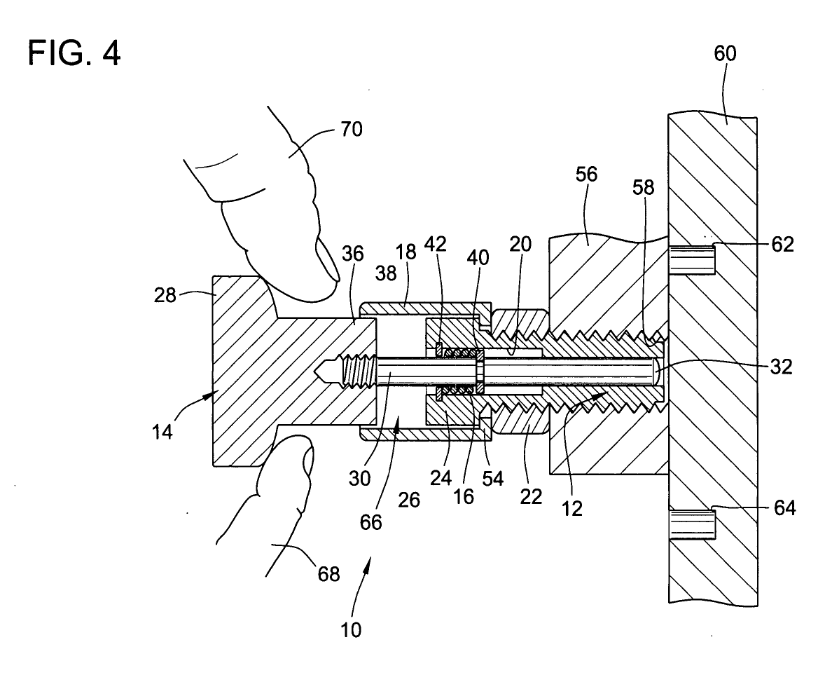

Moving to FIG. 4, the retractable plunger apparatus 10 is shown in a “disengaged” position. In the disengaged position, the locking element 32 has been retracted or drawn into the bushing and/or removed from the first socket 32 and the resilient member 16 has been further compressed (with respect to the resilient member of FIG. 3). Likewise, the abutment 24 and counter abutment 36 have been separated from each other such that a gap 66 is formed between the abutment 24 and counter abutment 36. Moreover, the sharp edges 26, 38 have been placed in spaced relation to each other. In the disengaged position, those skilled in the art will recognize that the first and second bodies 56, 60 can move relative to one another such that equipment attached to either of both of the first and second bodies can be indexed, adjusted, positioned, and the like.

Since, as shown in FIGS. 3 and 4, placing the retractable plunger apparatus 10 into the disengaged position is typically performed by one or more fingers 68 and/or a thumb 70 that grip the handle 28, draw the pin 30 through the bushing toward the handle, and retract the locking element 32 (against the bias of the resilient member 16) from the first socket 62, the gap 66 unfortunately provides an ideal, yet undesirable, place for the digits to become pinched when the handle is released and the guard 18 is not present. For example, without the guard 18 in place, when the handle 28 is released and the resilient member 16 expands to forcibly bring the abutment 24 and counter abutment 36 back into engagement, the finger 68 and/or thumb 70 can become compressed, squeezed, and/or squashed in between the abutment 24 and counter abutment 36. Since the abutment 24 and counter abutment 36 often include very well defined and/or sharp edges 26, 38, the fingers 68 and/or thumb 70 can be painfully injured.

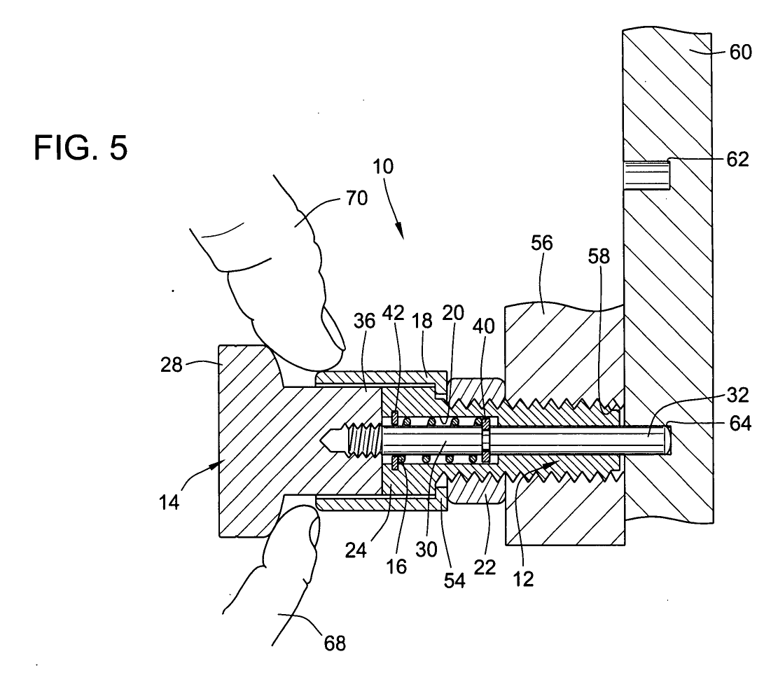

However, as shown in FIG. 4, the guard 18 protectively covers the gap 66 and/or resides over the abutment 24 and counter abutment 36. The guard 18 acts as a shield and/or sleeve that prohibits, or at least inhibits, the fingers 68 and thumb 70 from accidentally slipping into the gap and/or being caught between the sharp edges 26, 38 (i.e., in a pinch point). Notably, the coverage provided by the guard 18 is maintained as the retractable plunger 10 moves between the stopped position of FIG. 3 and the disengaged position of FIG. 4. Therefore, as the retractable plunger apparatus 10 is transitioned from the stopped position of FIG. 3, to the disengaged position of FIG. 4, and to a further stopped position of FIG. 5 (where the locking element projects into the second socket 64 after the first body 56 has been moved relative to the second body 60), the fingers 68 and thumb 70 of a user and/or other proximately situated person are protected from the gap 66 shown in FIG. 4.

With the exception of the guard 18, each of the remaining portions or pieces of the retractable plunger apparatus 10 are commercially available as a hand-retractable spring plunger or a quick release/retractable plunger from McMaster-Carr Supply Company of Elmhurst, Ill., and Vlier, Inc., of Brighton, Mass., respectively. These spring plungers can be ordered with variable amounts of force required to initially move the plunger relative to the bushing as well as the amount of force required to maintain the locking element retracted in the bushing. The retractable plunger apparatus 10 and/or components thereof can be, in preferred embodiments, fashioned from steel, stainless steel, brass, and like materials, and can have a plain, zinc-plated, black-oxide, and zinc-chromate finish.

All references, including publications, patent applications, and patents cited herein are hereby incorporated by reference to the same extent as if each reference were individually and specifically indicated to be incorporated by reference and were set forth in its entirely herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A retractable plunger apparatus comprising:
a bushing having an abutment;
a plunger having a handle, a counter abutment, and a locking element, the plunger slideable relative to the bushing and moveable between a stopped position wherein the counter abutment is engaged with the abutment and a disengaged position displaced from the stopped position wherein a gap is formed between the counter abutment and the abutment;
a resilient member supported by the bushing and urging the plunger and the bushing toward the stopped position; and
a guard protectively covering the gap as the plunger transitions between the stopped position and the disengaged position.

2. The retractable plunger apparatus of claim 1, wherein the plunger includes a cylindrical pin and the bushing includes a bore axially formed therein, the cylindrical pin slideably received within the bore.

3. The retractable plunger apparatus of claim 2, wherein the locking element is formed from a portion of the cylindrical pin protruding from the bushing.

4. The retractable plunger apparatus of claim 1, wherein the bushing is a threaded bolt having an axial bore formed therein.

5. The retractable plunger apparatus of claim 1, wherein the handle is selected from the group consisting of a knob, an L-handle, a pull-ring, and a T-handle.

6. The retractable plunger apparatus of claim 1, wherein the guard has a cylindrical body.

7. The retractable plunger apparatus of claim 6, wherein the guard has first and second circular openings at opposing ends of the cylindrical body, the first and second circular openings permitting the guard to pass over the bushing.

8. The retractable plunger apparatus of claim 7, wherein the guard provides a lip transverse to the body, the lip engageable with the bushing.

9. The retractable plunger apparatus of claim 1, wherein the bushing and the guard include mateable threads.

10. The retractable plunger apparatus of claim 1, wherein the resilient member is a spring.

11. The retractable plunger apparatus of claim 1, wherein the guard is secureable to the bushing with a threaded nut.

12. A hand-retractable spring plunger apparatus comprising:
a plunger having a handle, a pin, and a counter abutment;
a bushing having an axial bore and an abutment, the pin slideably received in the axial bore and protruding from the bushing to form a locking element;
a spring housed in the bushing, the spring operatively connected to the plunger and the bushing to urge the abutment and the counter abutment toward each other; and
a guard securable to the bushing and covering a gap formed between the abutment and the counter abutment when the locking element is retracted into the bushing.

13. The hand-retractable spring plunger apparatus of claim 12, wherein the guard is cylindrical and includes a radiused end proximate the handle.

14. The hand-retractable spring plunger apparatus of claim 12, wherein the handle is selected from the group consisting of a pull knob, a contoured delrin knob, an L-handle, a pull-ring, and a T-handle.

15. The hand-retractable spring plunger apparatus of claim 12, wherein the spring is operatively connected to the plunger and the bushing using at least one snap ring.

16. The hand-retractable spring plunger apparatus of claim 12, wherein the bushing is threaded.

17. A hand-retractable spring plunger system comprising:
a hand-retractable spring plunger apparatus including:
a plunger having a handle, a pin, and a counter abutment;
a bushing having an axial bore and an abutment, the pin slideably received in the axial bore and protruding from the bushing to form a locking element;
a spring housed in the bushing, the spring operatively connected to the plunger and the bushing to bias the abutment and the counter abutment toward each other; and
a guard telescopically received over the bushing and covering a gap formed between the abutment and the counter abutment when the locking element is retracted into the bushing;
a first body having an aperture, the bushing of the plunger apparatus mounted within the aperture; and
a second body, the first body locked relative to the second body via the locking element when the locking element is projecting from the bushing, the first body moveable relative to the second body when the locking element is retracted against the bias of the spring.

18. The hand-retractable spring plunger system of claim 17, wherein the locking element projects into a socket formed in the second body when the first body is locked relative to the second body.

19. The hand-retractable spring plunger system of claim 17, wherein the first body is indexed by retracting the locking element from the socket, moving the first body relative to the second body, and inserting the locking element into a further socket in the second body.

20. The hand-retractable spring plunger system of claim 17, wherein the aperture and the bushing are mateably threaded and the guard is securable to the bushing by a threaded nut.
